(19) United States
(12) Patent Application Publication
(10) Pub. No.: US 2012/0022953 A1
(43) Pub. Date: Jan. 26, 2012

(54) METHOD FOR DISPLAYING ADVERTISEMENT ON ELECTRONIC APPARATUS

(75) Inventor: Chun-Lung Cheng, Taipei Hsien (TW)

(73) Assignee: WISTRON CORPORATION, Taipei Hsien (TW)

(21) Appl. No.: 12/913,765

(22) Filed: Oct. 28, 2010

(30) Foreign Application Priority Data
Jul. 22, 2010 (TW) 99124181

(51) Int. Cl. G06Q 30/00

(52) U.S. Cl. 705/14.73

(57) ABSTRACT

A method for displaying an advertisement on an electronic apparatus is provided. When the electronic apparatus is ready to enter a specific status, an electronic ink (E-ink) display of the electronic apparatus displays an advertisement. The specific status can be a turn-off mode or a power-saving mode. When the electronic apparatus enters the specific status, a power supply of the electronic ink display is terminated. Therefore, the advertisement is still displayed on the electronic ink display even if the power supply of the electronic ink display terminated.

### CROSS-REFERENCE TO RELATED APPLICATION

This application claims the priority benefit of Taiwan application serial no. 99124181, filed on Jul. 22, 2010. The entirety of the above-mentioned patent application is hereby incorporated by reference herein and made a part of this specification.

### BACKGROUND OF THE INVENTION

1. Field of the Invention

The invention relates generally to a method for displaying an advertisement on an electronic apparatus, and more particularly to a method for displaying an advertisement on an electronic apparatus having an electronic ink (E-ink) display.

2. Description of Related Art

Nowadays, all types of advertisements permeate the streets to promote new products or to enhance the brand recognition of stores and products. Due to advancements in modern technologies, a store or a manufacturer may transmit advertising information to many consumers through a display on an electronic advertisement playback apparatus.

In addition, as portable electronic apparatuses (e.g., mobile phones, electronic readers) become popularized, people are gradually accustomed to gathering data on the web and accepting electronic books for reading. Under this environment, advertisers often place advertising content on a screen of a user's portable electronic apparatus, so as to promote a relevant product or service. Currently, an advertisement mode typically seen on the personable portable electronic apparatus displays an advertisement while the user operates the electronic apparatus. However, the user's operation is interrupted or terminated by the display of the advertisement. Moreover, displaying the advertisement consumes extra power from the electronic product. As the display time increases, the power consumption becomes substantial.

### SUMMARY OF THE INVENTION

An aspect of the invention provides a method for displaying an advertisement on an electronic apparatus. Before the electronic apparatus turns off or enters a power-saving mode, the electronic apparatus displays the advertisement on an electronic ink (E-ink) display thereof, so as to prolong an advertising impact.

Embodiments in accordance with the invention provide a method for displaying an advertisement on an electronic apparatus. The method includes determining whether the electronic apparatus is ready to enter a specific status, controlling the electronic apparatus to obtain an advertisement, and when the electronic apparatus is determined as ready to enter the specific status, the advertisement is displayed on an E-ink display of the electronic apparatus before the electronic apparatus enters the specific status. Moreover, after the advertisement is displayed on the electronic ink display, a power supply of the electronic ink display is terminated so the electronic apparatus enters the specific status.

According to an embodiment of the invention, the electronic apparatus includes a battery adapted for providing a power supply to the electronic apparatus. When the electronic apparatus enters the specific status, the battery terminates the power supply of the E-ink display.

According to an embodiment of the invention, the method further includes when the power supply of the E-ink display is restored, calculating a total time the advertisement is displayed on the E-ink display. Moreover, the calculated total time is transmitted to a service terminal.

According to an embodiment of the invention, the method further includes obtaining an identification information displayed on the E-ink display, and transmitting the identification information to a service terminal.

According to an embodiment of the invention, the method further includes transmitting from the service terminal a personalized information to the electronic apparatus according to the identification information.

According to an embodiment of the invention, the electronic apparatus extracts the advertisement from an electronic file.

According to an embodiment of the invention, the electronic file includes a plurality of content pages, and each of the content pages can be displayed on the E-ink display.

According to an embodiment of the invention, the electronic apparatus downloads the electronic file from a service terminal.

According to an embodiment of the invention, the electronic apparatus downloads the electronic file from the service terminal in a wireless transmission.

In summary, embodiments of the invention provide a method for displaying an advertisement on an electronic apparatus Before the electronic apparatus turns off or enters the power-saving mode, the advertisement is displayed on the E-ink display thereof, such that the advertisement can be continually displayed on the E-ink display even without being supplied power, thereby achieving a prolonged advertising impact under a low or zero power consuming condition.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an electronic apparatus according to an embodiment of the invention.

FIG. 2 is a flowchart illustrating a method for controlling the electronic apparatus depicted in FIG. 1 according to an embodiment of the invention.

FIG. 3 illustrates an interaction between the electronic apparatus depicted in FIG. 1, a service terminal, and a site.

### DESCRIPTION OF EMBODIMENTS

In order to achieve a sustained advertising impact under a low power or zero power consumption condition, embodiments of the invention employ an electronic ink (E-ink) display capable of maintaining a displayed content thereof even without being supplied power. Before an electronic apparatus is turned off or enters a power-saving mode, an advertisement is displayed on an E-ink display thereof. After the electronic apparatus is turned off or enters the power-saving mode, the E-ink display can still display the advertisement.

E-ink display technology was first developed in the 1970s and was characterized by small balls equipped with electric charges. One side of the balls is white, and the other side is black. When an electric field is altered, the balls are rotated upwardly or downwardly so as to exhibit different colors. The second-generation E-ink display technology was developed in the 1990s and was characterized by microcapsules filled with color oil and charged white particles in replacement of the conventional small balls. By controlling an external electric field, the charged white particles are moved upwardly or downwardly. When the charged white particles are moved upwardly (in a direction approaching a reader), the white color of the particles is exhibited. By contrast, when the charged white particles are moved downwardly (in a direction away from the reader), the color of the oil is exhibited.

In general, at present a common E-ink display includes a frontplane laminate (FPL) and a thin film transistor array substrate. The FPL has a transparent electrode layer and an E-ink material layer. The E-ink material layer has a plurality of microcapsules (i.e., E-ink) disposed therein, and each of the microcapsules includes black and white pigments and a transparent fluid. When an electric field between the transparent electrode layer and each pixel electrode of the thin film transistor array substrate is changed, the pigments move upward or downward according to a direction of the electric field, such that each pixel respectively displays the black color or the white color.

In recent years, development of a color E-ink display has gradually drawn more attention. U.S. Pat. No. 7,177,067 B1 discloses a color electronic paper display device, including a thin film transistor array substrate having a color filter layer and an E-ink material layer. The thin film transistor array substrate has a reflective electrode disposed thereon for reflecting an external light. The color electronic paper display device employs the E-ink material layer to control whether the external light can enter the color filter layer for light filtering, thereby displaying color.

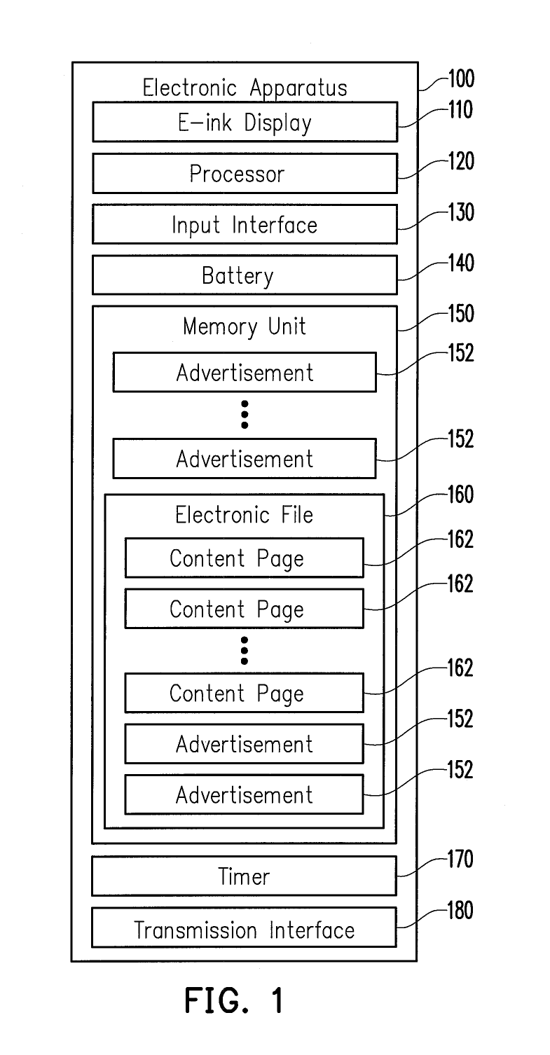

Referring to FIG. 1, FIG. 1 is a functional block diagram of an electronic apparatus according to an embodiment of the invention. An electronic apparatus 100 has an E-ink display 110, a processor 120, an input interface 130, a battery 140, and a memory unit 150. The E-ink display 110 is adapted for image display such that when a power supply is terminated, an originally displayed image can still be maintained for a prolonged period of time (e.g., several hours or days). The processor 120 is coupled to some components of the electronic apparatus 100, and the processor 120 is adapted for controlling an operation of the electronic apparatus 100. The input interface 130 is adapted for responding to an input from a user and generating a corresponding signal. In one embodiment of the invention, the input interface 130 has at least a button. In another embodiment, the input interface 130 and the E-ink display 110 are integrated into a touch screen. The battery 140 is adapted for providing a power supply required during the operation of the electronic apparatus 100. The memory unit 150 is adapted for storing an advertisement 152 or an electronic file 160. In one embodiment, the electronic file 160 is a file of an electronic book (e-book) including a plurality of content pages 162, and each of the content pages 162 can be displayed on the E-ink display 110.

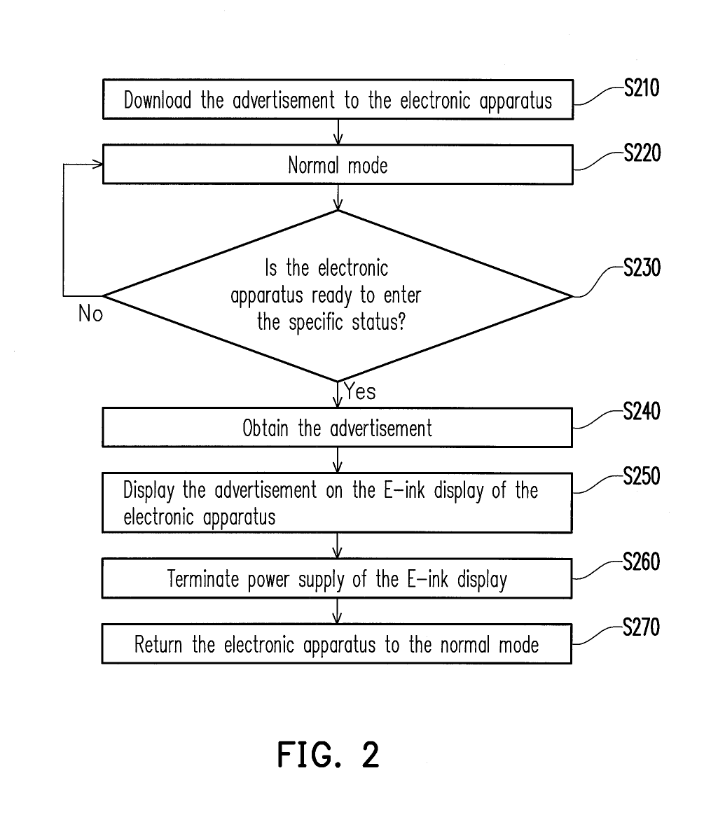

Referring to FIGS. 1 and 2, FIG. 2 is a flowchart illustrating a method for controlling the electronic apparatus 100 depicted in FIG. 1 according to an embodiment of the invention. Firstly, when the electronic apparatus 100 is operating under a normal mode, the processor 120 controls the electronic apparatus 100 to download the advertisement 152 to the memory unit 150 (Step S210). The normal mode refers to a mode relative to a turn-off mode and a power-saving mode of the electronic apparatus 100. A power consumption of the electronic device 100 under the normal mode is higher than the power consumption under the turn-off mode or the power-saving mode. When the electronic device 100 is operating under the turn-off mode or the power-saving mode, the battery 140 terminates providing a power supply to the E-ink display 110. In other words, when the electronic device 100 is operating under the turn-off mode or the power-saving mode, the E-ink display 110 does not waste power. In addition, it should be noted that, if the required advertisement 152 is already stored in the memory unit 150, then the afore-described Step S210 can be omitted.

Thereafter, the electronic device 100 operates under the normal mode (Step S220), and the processor 120 determines whether the electronic apparatus 100 is ready to enter a specific status according to a received signal from the input interface 130 (Step S230). The specific status includes the turn-off mode and the power-saving mode. For example, when the user wishes to turn off the electronic apparatus 100, the user can generate a power off signal via the input interface 130. When the processor 120 receives the power off signal from the input interface 130, the processor 120 determines in the Step S230 whether the electronic apparatus 100 is ready to enter the specific status. Thereafter, the processor 120 reads an advertisement to display from the memory unit 150 (Step S240), and displays the read advertisement on the E-ink display 110 of the electronic apparatus 100 (Step S250). It should be noted that, in the Step S240, the processor 120 may read the advertisement 152 to display from the memory unit 150 according to a predetermined sequence, or the processor 120 may randomly select an advertisement 152 from a plurality of advertisements 152 to display. Moreover, as shown in FIG. 1, the electronic file 160 not only has a plurality of content pages 162 but also a plurality of advertisements 152. Therefore, the advertisement 152 displayed on the E-ink display 110 may be selected from the advertisements 152 of the electronic file 160. For example, after the user finishes reading the content pages 162 of the electronic file 160 and wishes to turn off the electronic apparatus 100, the processor 120 can read the advertisements 152 of the electronic file 160 and display the read advertisement 152 on the E-ink display 110.

After the read advertisement 152 is displayed on the E-ink display 110, the processor 120 can control the battery 140 to terminate the power supply of the E-ink display 110, such that the electronic apparatus 100 enters the afore-described specific status (Step S260). Hence, in the present embodiment, after the electronic apparatus 100 enters the specific status, the E-ink display 110 can continually display the advertisement 152 and not waste power, thereby prolonging an advertising impact. Thereafter, through the input interface 130, the user can restart the electronic apparatus 100 or make the electronic apparatus 100 exit the power-saving mode and enter the normal mode, such that the electronic apparatus 100 returns to operation under the normal mode (Step S270).

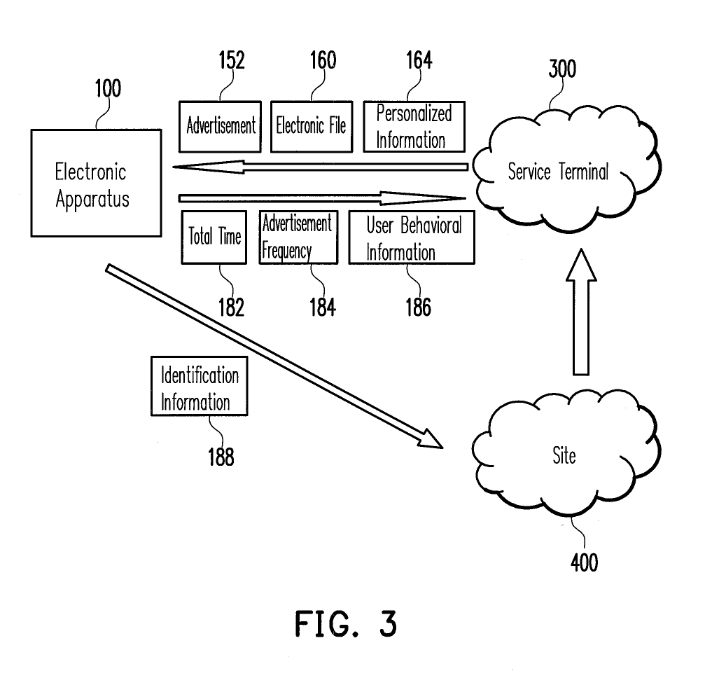

In one embodiment of the invention, besides the electronic apparatus 100 continually displaying the advertisement on the E-ink display 110 thereof while operating in the turn-off mode or the power-saving mode, the advertisement impact may be further assessed by analyzing a usage status from the user of the electronic apparatus 100. Referring to FIGS. 1 and 3, FIG. 3 illustrates an interaction between the electronic apparatus 100 depicted in FIG. 1, a service terminal 300, and a site 400. In one embodiment of the invention, the electronic apparatus 100 further includes a timer 170 and a transmission interface 180.

Through the transmission interface 180, the electronic apparatus 100 can download the advertisement 152 and the electronic file 160 from the service terminal 300.

In one embodiment, the transmission interface 180 transmits data wirelessly, such that the electronic apparatus 100 downloads the advertisement 152 and the electronic file 160 from the service terminal 300 in a wireless transmission.

Moreover, the electronic apparatus 100 can use the timer 170 to calculate a total time 182 in which the advertisement 152 is displayed on the E-ink display 110. The transmission interface 180 transmits the total time 182 calculated by the timer 170 to the service terminal 300. Accordingly, the service terminal 300 can analyze the advertising impact according to the received total time 182. Moreover, the electronic apparatus 100 may also transmit information such as an advertisement frequency 184 and a user behavioral information 186 to the service terminal 300, and accordingly the service terminal 300 can analyze the usage status of the advertisement 152 and a possible impact thereof. Moreover, an advertisement provider may adjust the content of the advertisements thereof according to an analytical result of the service terminal 300, thereby enhancing the advertising impact.

In one embodiment, the advertisement 152 displayed on the E-ink display 110 has an identification information 188. The identification information 188 is a barcode, a string, or a password, for example. The user can provide the identification information 188 to the site 400, where the identification information 188 is transmitted to the service terminal 300. After the service terminal 300 receives the identification information 188, the service terminal 300 can transmit a personalized information 164 to the electronic apparatus 100 according to the identification information 188. For example, in one embodiment, the site 400 is a store, and the advertisement 152 displayed on the E-ink display 110 is an advertisement for this store. When the user brings the electronic apparatus 100 to the site 400, the site 400 may give the user a corresponding discount benefit. Moreover, since the service terminal 300 received the identification information 188 provided by the site 400, the service terminal 300 may accordingly analyze a consumer habit of the user. Based on the consumer habit of the user, a related personalized information 164 is sent to the electronic apparatus 100 of the user, so as to encourage the user to undertake similar consumer actions.

In view of the foregoing, embodiments of the invention provide a method for displaying an advertisement on an electronic apparatus. Before the electronic apparatus turns off or enters the power-saving mode, the advertisement is displayed on the E-ink display thereof, such that the advertisement can be continually displayed on the E-ink display even without being supplied power, thereby achieving a prolonged advertising impact under a low power consuming condition.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A method for displaying an advertisement on an electronic apparatus, comprising:
determining whether the electronic apparatus is ready to enter a specific status;
controlling the electronic apparatus to obtain an advertisement;
when the electronic apparatus is determined as ready to enter the specific status, displaying the advertisement on an electronic ink (E-ink) display of the electronic apparatus before the electronic apparatus enters the specific status; and
after the advertisement is displayed on the electronic ink display, terminating a power supply of the electronic ink display so the electronic apparatus enters the specific status.

2. The method as claimed in claim 1, wherein the electronic apparatus comprises a battery adapted for providing a power supply to the electronic apparatus, and when the electronic apparatus enters the specific status, the battery terminates the power supply of the E-ink display.

3. The method as claimed in claim 1, further comprising:
when the power supply of the E-ink display is restored, calculating a total time the advertisement is displayed on the E-ink display; and
transmitting the calculated total time to a service terminal.

4. The method as claimed in claim 1, further comprising:
obtaining an identification information displayed on the E-ink display; and
transmitting the identification information to a service terminal.

5. The method as claimed in claim 4, further comprising:
transmitting a personalized information from the service terminal to the electronic apparatus according to the identification information.

6. The method as claimed in claim 1, wherein the electronic apparatus extracts the advertisement from an electronic file.

7. The method as claimed in claim 6, wherein the electronic file comprises a plurality of content pages, and each of the content pages is displayable on the E-ink display.

8. The method as claimed in claim 6, wherein the electronic apparatus downloads the electronic file from a service terminal.

9. The method as claimed in claim 8, wherein the electronic apparatus downloads the electronic file from the service terminal in a wireless transmission.
